(19) United States
(12) Patent Application Publication
(10) Pub. No.: US 2026/0164335 A1
(43) Pub. Date: Jun. 11, 2026

(54) CONNECTION ESTABLISHMENT ACROSS FAILURE DOMAINS IN COMPONENT LAYERS OF A TARGET SYSTEM

(71) Applicant: Dell Products L.P., Round Rock, TX (US)

(72) Inventor: Rivka Mayraz Matosevich, Zichron Ya'acov (IL)

(21) Appl. No.: 18/971,226

(22) Filed: Dec. 6, 2024

(51) Int. Cl. H04W 40/24; H04L 65/1069

(52) U.S. Cl. CPC H04W 40/246; H04L 65/1069

(57) ABSTRACT

An apparatus comprises at least one processing device configured to determine an identifier and a number of connections to establish between a given initiator node and a target system. The at least one processing device is also configured to send a discovery request to the target system and to receive from the target system a discovery response with entries for system ports of the target system order based on a topology of component layers of the target system. The at least one processing device is further configured to parse the discovery response to select, based on the identifier of the given initiator node and the number of connections, a subset of the system ports distributed across different failure domains in at least one of the component layers and to establish a connection between the given initiator node and each of the system ports in the selected subset.

### BACKGROUND

Information processing systems often include distributed arrangements of multiple nodes, also referred to herein as distributed processing systems. Such systems can include, for example, distributed storage systems comprising multiple storage nodes. These distributed storage systems are often dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. Data within the system is partitioned, striped, and replicated across the distributed storage nodes. For a storage administrator, the software-defined storage system provides a logical view of a given dynamic storage pool that can be expanded or contracted at ease, with simplicity, flexibility, and different performance characteristics. For applications running on a host device that utilizes the software-defined storage system, such a storage system provides a logical storage object view to allow a given application to store and access data, without the application being aware that the data is being dynamically distributed among different storage nodes potentially at different sites.

### SUMMARY

Illustrative embodiments of the present disclosure provide techniques for connection establishment across failure domains in component layers of a target system.

In one embodiment, an apparatus comprises at least one processing device comprising a processor coupled to a memory. The at least one processing device is configured to determine, for a given one of a plurality of initiator nodes of a source system, an identifier and a number of connections to establish between the given initiator node and a target system. The at least one processing device is also configured to send, to the target system, a discovery request and to receive, from the target system, a discovery response, the discovery response comprising entries for system ports of the target system, wherein an ordering of the entries in the discovery response is based at least in part on a topology of two or more component layers of the target system. The at least one processing device is further configured to parse the discovery response to select, based at least in part on the identifier of the given initiator node and the number of connections, a subset of the system ports of the target system, the selected subset of the system ports of the target system being distributed across different failure domains in at least one of the two or more component layers of the target system. The at least one processing device is further configured to establish a connection between the given initiator node and each of the system ports in the selected subset of the system ports of the target system.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for connection establishment across failure domains in component layers of a target system in an illustrative embodiment.

FIGS. 2A-2C are block diagrams of an information processing system implementing a source or a target system configured for connection establishment across failure domains in component layers of the target system in an illustrative embodiment.

FIG. 3 shows system port information for a target system in an illustrative embodiment.

FIG. 4 shows a discovery response output for a target system having entries ordered to enable a source system to establish resilient connections to the target system in an illustrative embodiment.

FIG. 5 shows assignment of system ports of a target system to initiators of a source system using a discovery response output having entries ordered to enable the source system to establish resilient connections to the target system in an illustrative embodiment.

FIG. 6 is a flow diagram of an exemplary process for connection establishment across failure domains in component layers of a target system in an illustrative embodiment.

FIG. 7 schematically illustrates an example framework of a node for implementing a compute, storage or management node of a source or target system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

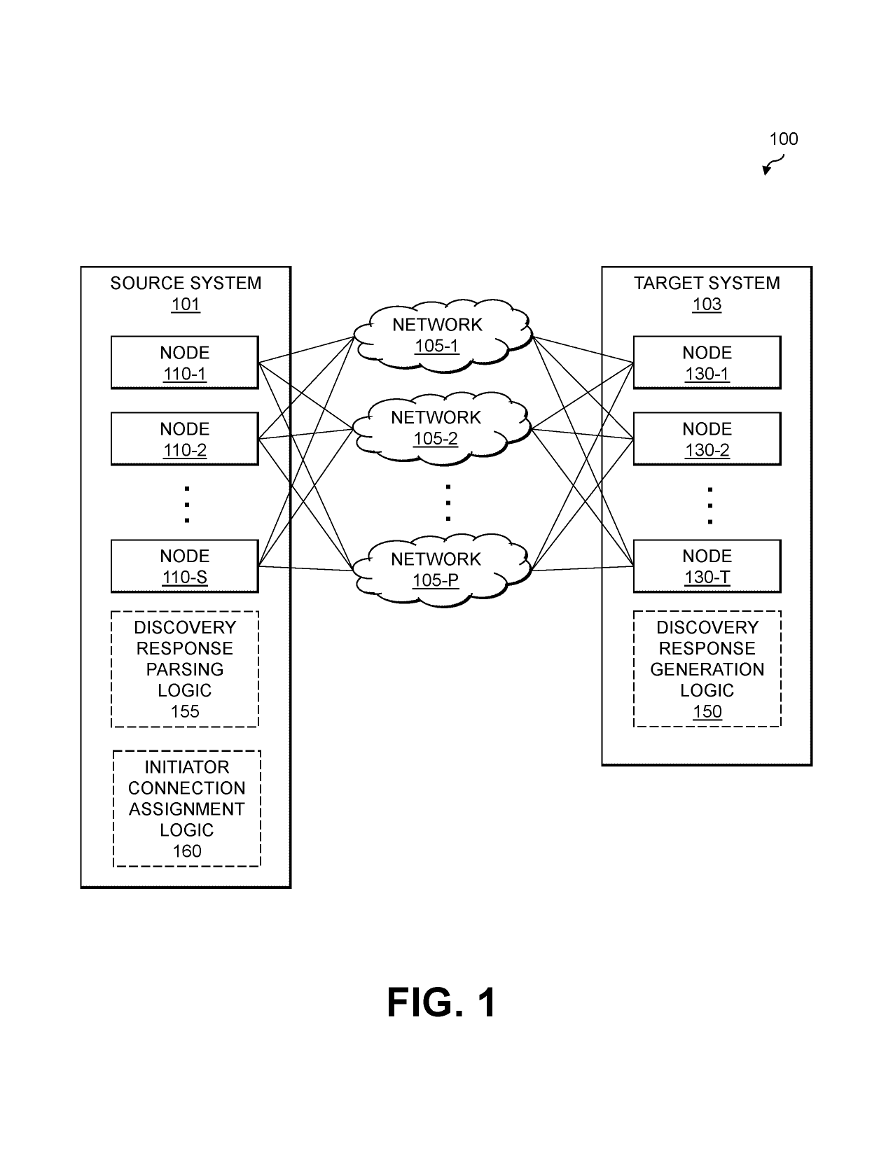

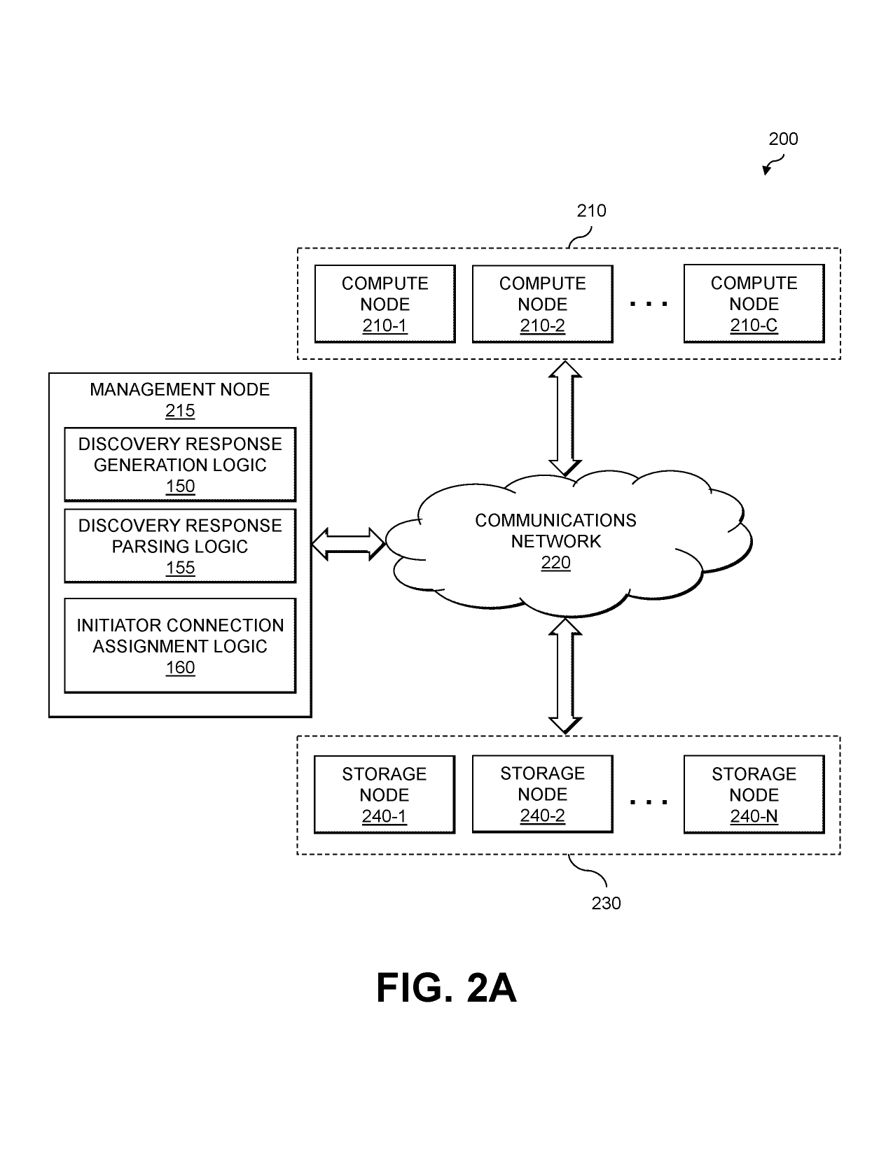

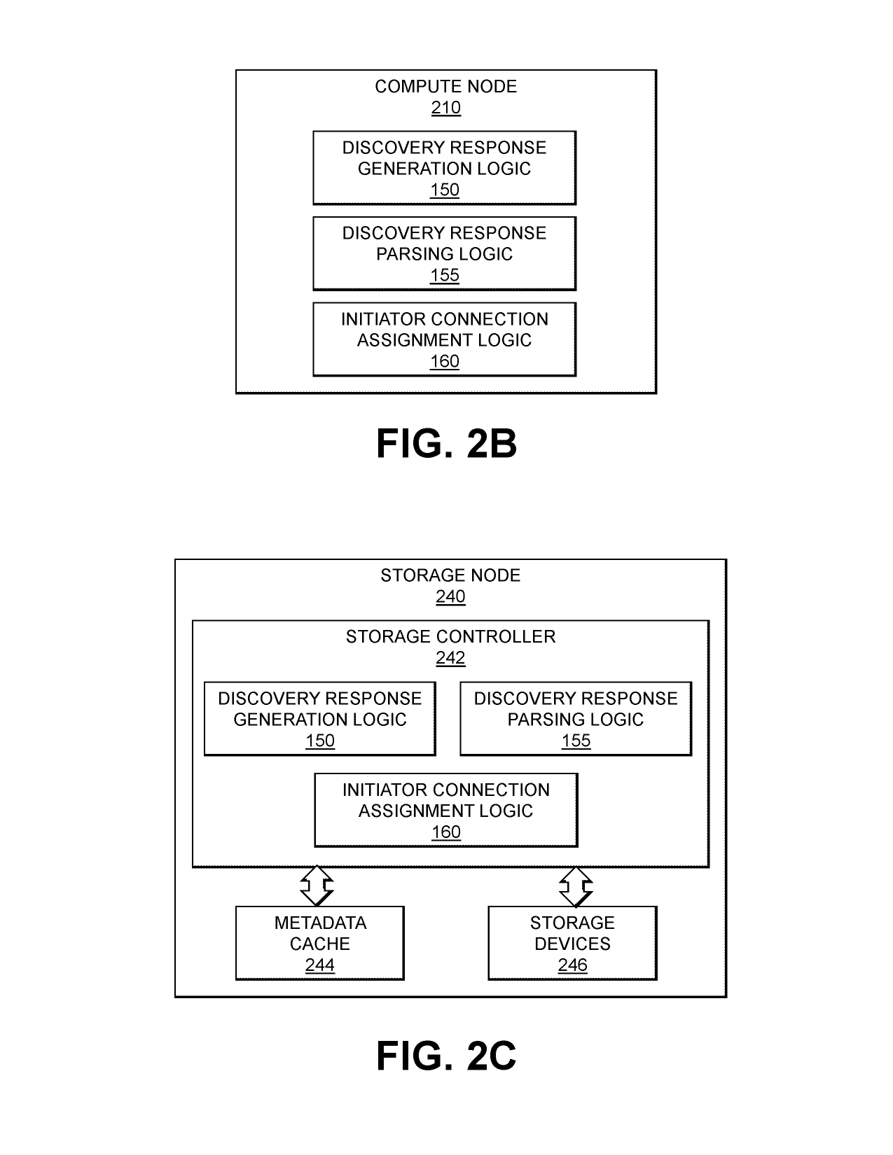

FIG. 1 schematically illustrates an information processing system 100 which is configured to implement functionality for connection establishment between a source system 101 and a target system 103, across failure domains in component layers of the target system 103, according to an exemplary embodiment of the disclosure. The source system 101 (which may also be referred to as an “initiator” system) comprises a set of nodes 110-1, 110-2, . . . 110-S (collectively, nodes 110) and the target system comprises a set of nodes 130-2, 130-2, . . .130-T (collectively, nodes 130). The nodes 110 of the source system 101 are connected to the nodes 130 of the target system 103 over a set of networks 105-1, 105-2, . . . 105-P (collectively, networks 105). Each of the nodes 110 and 130 may be or provide functionality of a “compute” node, a “storage” node or a “management” node as described in further detail below with respect to the information processing system 200 shown in FIGS. 2A-2C.

Data mobility features, such as asynchronous replication, synchronous replication, volume migration between storage systems, etc., require two or more systems (e.g., the source system 101 and the target system 103) to connect and transmit data between them. Scale-out systems may achieve performance benefits by utilizing many relatively small nodes, each carrying out an approximately equal portion of the workload. The ability to perform well and scale this performance when more nodes (e.g., nodes 110 and/or nodes 130) are added relies on a suitable method of distributing the load over the available nodes, thus achieving improved utilization of system resources.

In some cases, data mobility operations require that one or more of the nodes 110 of the source system 101 has a “resilient” connection to the target system 103. A resilient connection refers to a condition whereby an initiator (e.g., one of the nodes 110) of the source system 101 will remain connected to the target system 103 in the presence of one or more designated failure conditions. For example, the connection may be resilient to failure in different “component” layers (also referred to as hardware layers or connection layers). The component layers may include a network component layer (e.g., where there is resiliency to failure of one or more of the networks 105 interconnecting the nodes 110 of the source system 101 with the nodes 130 of the target system 103, where the network 105 may be different network subnets or other designated network portions), a node component layer (e.g., where there is a resiliency to failure of one or more of the nodes 130 of the target system 103), a failure set component layer (e.g., where there is a resiliency to failure in one or more failure sets associated with the target system 103, such as system ports of nodes 130 of the target system 103 which are connected to the same power supply, etc.). Each of the nodes 110 in the source system 101 may support a limited number of connections as an initiator, and each of the nodes 130 in the target system 103 may support a limited number of connections as a target. In some embodiments, it is desired to limit the number of connections that each of the nodes 110 and 130 must support, even for scale-out systems that support many storage nodes and system ports.

In the information processing system 100 shown in FIG. 1, the target system 103 implements discovery response generation logic 150 while the source system 101 implements discovery response parsing logic 155 and initiator connection assignment logic 160. For clarity of illustration, in FIG. 1 the discovery response generation logic 150 is shown in dashed outline external to the nodes 130 of the target system 103. Any one of or combination of the nodes 130 of the target system 103 may host and implement an instance of the discovery response generation logic 150. Similarly, although shown in dashed outline external to the nodes 110 of the source system 101, any one of or combination of the nodes 110 of the source system 101 may host and implement instances of the discovery response parsing logic 155 and the initiator connection assignment logic 160.

One or more of the nodes 110 of the source system 101 (e.g., acting as an initiator) sends a discovery request to the target system 103 (e.g., to one or more of the nodes 130 of the target system 103). Using the discovery response generation logic 150, the target system 103 (e.g., one or more of the nodes 103 thereof) generates a discovery response with entries ordered in a particular fashion which enables the source system 101 (e.g., one or more of the nodes 110 thereof) to establish resilient connections to the target system 103. When ordering the list, the discovery response generation logic 150 considers the topology of system components of the target system 103 across different component layers (e.g., a node component layer, a network component layer, a failure set component layer, etc.) to identify which elements in the target system 103 may fail together. The entries for those elements that fail together are placed further apart in the generated discovery response. For example, entries for two system ports connecting to the same one of the networks 105, or two system ports in nodes 130 which are connected to the same power supply (e.g., representing a possible failure set) would be spaced apart in the generated discovery response.

Using the discovery response parsing logic 155, the source system 101 (e.g., one or more of the nodes 110 thereof) will parse the generated discovery response, to determine a specific ordering of entries for system ports of the nodes 130 of the target system 103. The source system 101 (e.g., one or more of the nodes 110 thereof) utilizes the initiator connection assignment logic 160 to determine which system ports of the nodes 130 of the target system 103 that each of the initiators (e.g., system ports of the nodes 110) should connect to across different failure domains in one or more of the component layers of the target system 103.

FIGS. 2A-2C schematically illustrate an information processing system 200 which is configured to implement a source (initiator) system (e.g., source system 101 in FIG. 1) or a target system (e.g., target system 103 in FIG. 1). More specifically, FIG. 2A schematically illustrates the information processing system 200 which comprises a plurality of compute nodes 210-1, 210-2, …., 210-C (collectively referred to as compute nodes 210, or each singularly referred to as a compute node 210), one or more management nodes 215 (which support a management layer of the system 200), a communications network 220, and a data storage system 230 (which supports a data storage layer of the system 200). The data storage system 230 comprises a plurality of storage nodes 240-1, 240-2, …, 240-N (collectively referred to as storage nodes 240, or each singularly referred to as a storage node 240). In the context of the exemplary embodiments described herein, the compute nodes 210, the management nodes 215 and the data storage system 230 implement logic supporting the establishment of resilient connections between the system 200 (e.g., which may be a “source” system such as source system 101 or a “target” system such as target system 103) and another system (e.g., which is the other of the “source” system and the “target” system). FIG. 2B schematically illustrates an exemplary framework of at least one or more of the compute nodes 210, and FIG. 2C schematically illustrates an exemplary framework of at least one or more of the storage nodes 240.

As shown in FIG. 2C, the storage node 240 comprises a storage controller 242, a metadata cache 244 and a plurality of storage devices 246. In general, the storage controller 242 implements data storage and management methods that are configured to divide the storage capacity of the storage devices 246 into storage pools and logical volumes. Storage controller 242 is further configured to implement the discovery response generation logic 150, the discovery response parsing logic 155 and the initiator connection assignment logic 160 in accordance with the disclosed embodiments. Various other examples are possible. It is to be noted that the storage controller 242 may include additional modules and other components typically found in conventional implementations of storage controllers and storage systems, although such additional modules and other components are omitted for clarity and simplicity of illustration.

In the embodiment of FIGS. 2A-2C, the discovery response generation logic 150, the discovery response parsing logic 155 and the initiator connection assignment logic 160 may be implemented at least in part within the one or more compute nodes 210 and/or the one or more management nodes 215, as well as in one or more of the storage nodes 240 of the data storage system 230. This may include implementing different portions of the functionality of the discovery response generation logic 150, the discovery response parsing logic 155 and the initiator connection assignment logic 160 in different ones of the compute nodes 210, the management nodes 215 and/or the storage nodes 240. It should be noted that the system 200 may be a “source” or a “target” system, and thus the compute nodes 210, the management nodes 215 and the storage nodes 240 are illustrated as including the initiator or source-side logic (e.g., the discovery response parsing logic 155 and the initiator connection assignment logic 160) as well as the target-side logic (e.g., the discovery response generation logic 150).

The compute nodes 210 illustratively comprise physical compute nodes and/or virtual compute nodes which process data and execute workloads. For example, the compute nodes 210 can include one or more servers (e.g., bare metal servers) and/or one or more virtual machines. In some embodiments, the compute nodes 210 comprise a cluster of physical servers or other types of computers of an enterprise computer system, cloud-based computing system or other arrangement of multiple compute nodes associated with respective users. In some embodiments, the compute nodes 210 include a cluster of virtual machines that execute on one or more physical servers.

The compute nodes 210 are configured to process data and execute tasks/workloads and perform computational work, either individually, or in a distributed manner, to thereby provide compute services such as execution of one or more applications on behalf of each of one or more users associated with respective ones of the compute nodes. Such applications illustratively issue input-output (IO) requests that are processed by a corresponding one of the storage nodes 240. The term “input-output” as used herein refers to at least one of input and output. For example, IO requests may comprise write requests and/or read requests directed to stored data of a given one of the storage nodes 240 of the data storage system 230.

The compute nodes 210 are configured to write data to and read data from the storage nodes 240 in accordance with applications executing on those compute nodes for system users. The compute nodes 210 communicate with the storage nodes 240 over the communications network 220. While the communications network 220 is generically depicted in FIG. 2A, it is to be understood that the communications network 220 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., Ethernet storage network), or various portions or combinations of these and other types of networks.

In this regard, the term “network” as used herein is therefore intended to be broadly construed so as to encompass a wide variety of different network arrangements, including combinations of multiple networks possibly of different types, which enable communication using, e.g., Transfer Control/Internet Protocol (TCP/IP) or other communication protocols such as Fibre Channel (FC), FC over Ethernet (FCoE), Internet Small Computer System Interface (iSCSI), Peripheral Component Interconnect express (PCIe), InfiniBand, Gigabit Ethernet, etc., to implement IO channels and support storage network connectivity. Numerous alternative networking arrangements are possible in a given embodiment, as will be appreciated by those skilled in the art.

The data storage system 230 may comprise any type of data storage system, or a combination of data storage systems, including, but not limited to, a storage area network (SAN) system, a network attached storage (NAS) system, a direct-attached storage (DAS) system, etc., as well as other types of data storage systems comprising software-defined storage, clustered or distributed virtual and/or physical infrastructure. The term “data storage system” as used herein should be broadly construed and not viewed as being limited to storage systems of any particular type or types. In some embodiments, the storage nodes 240 comprise storage server nodes having one or more processing devices each having a processor and a memory, possibly implementing virtual machines and/or containers, although numerous other configurations are possible. In some embodiments, one or more of the storage nodes 240 can additionally implement functionality of a compute node, and vice-versa. The term “storage node” as used herein is therefore intended to be broadly construed, and a storage system in some embodiments can be implemented using a combination of storage nodes and compute nodes.

In some embodiments, as schematically illustrated in FIG. 2C, the storage node 240 is a physical server node or storage appliance, wherein the storage devices 246 comprise DAS resources (internal and/or external storage resources) such as hard-disk drives (HDDs), solid-state drives (SSDs), Flash memory cards, or other types of non-volatile memory (NVM) devices such as non-volatile random access memory (NVRAM), phase-change RAM (PC-RAM) and magnetic RAM (MRAM). These and various combinations of multiple different types of storage devices 246 may be implemented in the storage node 240. In this regard, the term “storage device” as used herein is intended to be broadly construed, so as to encompass, for example, SSDs, HDDs, flash drives, hybrid drives or other types of storage media. The storage devices 246 are connected to the storage node 240 through any suitable host interface, e.g., a host bus adapter, using suitable protocols such as Advanced Technology Attachment (ATA), Serial ATA (SATA), External SATA (eSATA), Non-Volatile Memory Express (NVMe), NVMe Over Fabric (NVMe-oF), Small Computer System Interface (SCSI), Serial Attached SCSI (SAS), etc. In other embodiments, the storage node 240 can be network connected to one or more NAS nodes over a local area network. The metadata cache 244 may be implemented using memory resources.

The storage controller 242 is configured to manage the metadata cache 244 and the storage devices 246, and to control IO access to the metadata cache 244, the storage devices 246 and/or other storage resources (e.g., DAS or NAS resources) that are directly attached or network-connected to the storage node 240. In some embodiments, the storage controller 242 is a component (e.g., storage data server) of a software-defined storage (SDS) system which supports the virtualization of the storage devices 246 by separating the control and management software from the hardware architecture. More specifically, in a software-defined storage environment, the storage controller 242 comprises an SDS storage data server that is configured to abstract storage access services from the underlying storage hardware to thereby control and manage IO requests issued by the compute nodes 210, as well as to support networking and connectivity. In this instance, the storage controller 242 comprises a software layer that is hosted by the storage node 240 and deployed in the data path between the compute nodes 210 and the storage devices 246 of the storage node 240, and is configured to respond to data IO requests from the compute nodes 210 by accessing the storage devices 246 to store/retrieve data to/from the storage devices 246 based on the IO requests. Processing of the data IO requests may utilize various metadata, which may be stored in the metadata cache 244 (e.g., for faster access) or in the storage devices 246 themselves.

In a software-defined storage environment, the storage controller 242 is configured to provision, orchestrate and manage the local storage resources (e.g., the storage devices 246) of the storage node 240. For example, the storage controller 242 implements methods that are configured to create and manage storage pools (e.g., virtual pools of block storage) by aggregating capacity from the storage devices 246. The storage controller 242 can divide a storage pool into one or more volumes and expose the volumes to the compute nodes 210 as virtual block devices. For example, a virtual block device can correspond to a volume of a storage pool. Each virtual block device comprises any number of actual physical storage devices, wherein each block device is preferably homogenous in terms of the type of storage devices that make up the block device (e.g., a block device only includes either HDD devices or SSD devices, etc.).

In the software-defined storage environment, each of the storage nodes 240 in FIG. 2A can run an instance of the storage controller 242 to convert the respective local storage resources (e.g., DAS storage devices and/or NAS storage devices) of the storage nodes 240 into local block storage. Each instance of the storage controller 242 contributes some or all of its local block storage (HDDs, SSDs, PCIe, NVMe and flash cards) to an aggregated pool of storage of a storage server node cluster (e.g., cluster of storage nodes 240) to implement a server-based storage area network (SAN) (e.g., virtual SAN). In this configuration, each storage node 240 is part of a loosely coupled server cluster which enables “scale-out” of the software-defined storage environment, wherein each instance of the storage controller 242 that runs on a respective one of the storage nodes 240 contributes its local storage space to an aggregated virtual pool of block storage with varying performance tiers (e.g., HDD, SSD, etc.) within a virtual SAN.

In some embodiments, in addition to the storage controllers 242 operating as SDS storage data servers to create and expose volumes of a storage layer, the software-defined storage environment comprises other components such as (i) SDS data clients that consume the storage layer and (ii) SDS metadata managers that coordinate the storage layer, which are not specifically shown in FIG. 2A. More specifically, on the client-side (e.g., compute nodes 210), an SDS data client (SDC) is a lightweight block device driver that is deployed on each server node that consumes the shared block storage volumes exposed by the storage controllers 242. In particular, the SDCs run on the same servers as the compute nodes 210 which require access to the block devices that are exposed and managed by the storage controllers 242 of the storage nodes 240. The SDC exposes block devices representing the virtual storage volumes that are currently mapped to that host. In particular, the SDC serves as a block driver for a client (server), wherein the SDC intercepts IO requests, and utilizes the intercepted IO request to access the block storage that is managed by the storage controllers 242. The SDC provides the operating system or hypervisor (which runs the SDC) access to the logical block devices (e.g., volumes).

The SDCs have knowledge of which SDS control systems (e.g., which instances of the storage controller 242) hold its block data, so multipathing can be accomplished natively through the SDCs. In particular, each SDC knows how to direct an IO request to the relevant destination SDS storage data server (e.g., storage controller 242). In this regard, there is no central point of routing, and each SDC performs its own routing independent from any other SDC. This implementation prevents unnecessary network traffic and redundant SDS resource usage. Each SDC maintains peer-to-peer connections to every storage controller 242 that manages the storage pool. A given SDC can communicate over multiple pathways to all of the storage nodes 240 which store data that is associated with a given IO request. This multi-point peer-to-peer fashion allows the SDS to read and write data to and from all points simultaneously, eliminating bottlenecks and quickly routing around failed paths.

The management nodes 215 in FIG. 2A implement a management layer that is configured to manage and configure the storage environment of the system 200. In some embodiments, the management nodes 215 comprise the SDS metadata manager components, wherein the management nodes 215 comprise a tightly-coupled cluster of nodes that are configured to supervise the operations of the storage cluster and manage storage cluster configurations. The SDS metadata managers operate outside of the data path and provide the relevant information to the SDS clients and storage servers to allow such components to control data path operations. The SDS metadata managers are configured to manage the mapping of SDC data clients to the SDS data storage servers. The SDS metadata managers manage various types of metadata that are required for system operation of the SDS environment such as configuration changes, managing the SDS data clients and data servers, device mapping, values, snapshots, system capacity including device allocations and/or release of capacity, RAID protection, recovery from errors and failures, and system rebuild tasks including rebalancing.

While FIG. 2A shows an exemplary embodiment of a two-layer deployment in which the compute nodes 210 are separate from the storage nodes 240 and connected by the communications network 220, in other embodiments, a converged infrastructure (e.g., hyperconverged infrastructure) can be implemented to consolidate the compute nodes 210, storage nodes 240, and communications network 220 together in an engineered system. For example, in a hyperconverged deployment, a single-layer deployment is implemented in which the storage data clients and storage data servers run on the same nodes (e.g., each node deploys a storage data client and storage data servers) such that each node is a data storage consumer and a data storage supplier. In other embodiments, the system of FIG. 2A can be implemented with a combination of a single-layer and two-layer deployment.

Regardless of the specific implementation of the storage environment, as noted above, various modules of the storage controller 242 of FIG. 2B collectively provide data storage and management methods that are configured to perform various functions as follows. In particular, a storage virtualization and management services module may implement any suitable logical volume management (LVM) system which is configured to create and manage local storage volumes by aggregating the storage devices 246 into one or more virtual storage pools that are thin-provisioned for maximum capacity, and logically dividing each storage pool into one or more storage volumes that are exposed as block devices (e.g., raw logical unit numbers (LUNs)) to the compute nodes 210 to store data. In some embodiments, the storage devices 246 are configured as block storage devices where raw volumes of storage are created and each block can be controlled as, e.g., an individual disk drive by the storage controller 242. Each block can be individually formatted with a same or different file system as required for the given data storage system application.

In some embodiments, the storage pools are primarily utilized to group storage devices based on device types and performance. For example, SSDs are grouped into SSD pools, and HDDs are grouped into HDD pools. Furthermore, in some embodiments, the storage virtualization and management services module implements methods to support various data storage management services such as data protection, data migration, data deduplication, replication, thin provisioning, snapshots, data backups, etc.

Storage systems, such as the data storage system 230 of system 200, may be required to provide both high performance and a rich set of advanced data service features for end-users thereof (e.g., users operating compute nodes 210, applications running on compute nodes 210). Performance may refer to latency, or other metrics such as IO operations per second (IOPS), bandwidth, etc. Advanced data service features may refer to data service features of storage systems including, but not limited to, services for data resiliency, thin provisioning, data reduction, space efficient snapshots, etc. Fulfilling both performance and advanced data service feature requirements can represent a significant design challenge for storage systems. This may be due to different advanced data service features consuming significant resources and processing time. Such challenges may be even greater in software-defined storage systems in which custom hardware is not available for boosting performance.

Device tiering may be used in some storage systems, such as in storage systems that contain some relatively “fast” and expensive storage devices and some relatively “slow” and less expensive storage devices. In device tiering, the “fast” devices may be used when performance is the primary requirement, where the “slow” and less expensive devices may be used when capacity is the primary requirement. Such device tiering may also use cloud storage as the “slow” device tier. Some storage systems may also or alternately separate devices offering the same performance level to gain performance isolation between different sets of storage volumes. For example, the storage systems may separate the “fast” devices into different groups to gain performance isolation between storage volumes on such different groups of the “fast” devices.

As discussed above, data mobility features, such as asynchronous replication, synchronous replication, volume migration between storage systems, etc., require two or more storage systems (e.g., a “source” system and a “target” system) to connect and transmit data between them. Scale-out storage systems may achieve performance benefits by utilizing many relatively small storage nodes, each carrying out an approximately equal portion of the workload. The ability to perform well and scale this performance when more storage nodes are added relies on a suitable method of distributing the load over the available storage nodes, thus achieving improved utilization of storage system resources.

When the storage systems involved in data mobility operations are scale-out storage systems, the data mobility workload is typically spread over the resources (e.g., of different storage nodes and/or compute nodes) of the storage systems. If the workload is not well spread, some of the storage nodes, networks, etc., will be more loaded than others, resulting in reduced performance of the overall storage system.

In some cases, data mobility operations require that each storage node of a source system (e.g., a source storage system) has a “resilient” connection to a target system (e.g., a target storage system). A resilient connection refers to a condition whereby a node (e.g., an initiator) of the source system will remain connected in the presence of one or more designated failure conditions. For example, the connection may be resilient to the failure of a network (e.g., a network subnet), a storage node of the target system, a failure set, etc. The specific set of failure conditions that the connection must survive to be considered resilient depends on the implementation and topology of the source and target systems as well as the networks interconnecting the source and target systems. Each node in a system (e.g., each storage node in a storage system, each compute node in a computing system, etc.) may support a limited number of connections as an initiator or a target. In some embodiments, it is desired to limit the number of connections that each node, initiator and/or target must support, even for scale-out storage systems that support many storage nodes and system ports.

A data mobility solution can use multiple protocols to transfer data, including iSCSI, NVMe-oF, proprietary protocols, etc. iSCSI and NVMe-oF support discovery protocols that allow the initiator side to perform discovery through a single special connection and receive the list of available system ports to which the initiator may connect to perform IO. Protocols such as iSCSI and NVMe-oF have a standard format for returning the discovery output. The discovery output typically includes the information on the destination system ports (e.g., IP address in the case of TCP) to which the initiator may connect. The discovery output does not include information the initiator can use to connect to the target system in a resilient and balanced manner. That is, the discovery output in conventional approaches does not include an identification of the networks, nodes, failure sets, etc., associated with each of the system ports of the target system.

To achieve resiliency, a trivial solution is to have each initiator at the source system connect to all system ports of the target system that are listed in the discovery output (e.g., a response to a discovery request). This, however, is not practical in various scenarios. For example, scale-out storage systems may have many storage nodes, and connecting full mesh from all the initiators to all the system ports of the target system creates an extremely large number of connections. Thus, such an approach does not scale, even if each connection uses minimal system resources.

In conventional approaches, after performing discovery, an initiator (e.g., of a node of a source system) will have a list of system ports (e.g., of one or more nodes of a target system), but no information that helps the initiator ensure that a connection between the node of the source system and the target system is resilient and balanced. Illustrative embodiments provide technical solutions for enabling resilient and balanced connections among nodes of source and target systems though intelligent control of the ordering of the discovery output data. The initiators on nodes of the source system are provisioned with logic to understand the order of entries in the discovery output so as to establish resilient and balanced connections with the target system, without needing to understand a topology of the target system.

The connection topology between source and target systems may have multiple component layers (e.g., network, node, failure set, etc.). Each system port of a target system belongs to a specific instance in each of the multiple component layers. For example, a TCP system port is part of a particular TCP subnet and located on a node (e.g., a storage node) that is a member of a particular failure set. A priority may be assigned to each of the multiple component layers in the connection topology. The priority considers the likelihood of a failure in each component layer and, therefore, the priority of distributing the initiator connections over separate instances in that component layer. Such different instances within a component layer are examples of what is more generally referred to herein as a failure domain. A failure domain represents a grouping of entities within a particular component layer that are likely to fail together. For example, in the network component layer, network subnets are examples of failure domains. In the node component layer, nodes are examples of failure domains (e.g., a node may have multiple system ports, so that if the node fails all its system ports would fail together). In the failure set component layer, each failure set represents a failure domain. Various other examples are possible for other types of component layers. By way of example, individual nodes may include multiple distinct sets of system ports that are expected to fail together, such as a node that includes distinct interface cards each having its own set of system ports. In this example, the failure domain would be a particular interface card of a particular node having a set of system ports. In some embodiments, the network component layer has the highest priority, the node component layer has the next highest priority, and the failure set component layer has the lowest priority. If there are two component layers with the same likelihood of failing, one may be randomly selected to have a higher priority.

Generation of a discovery output at a target system will now be described. The target system identifies the association of each system port with each of the component layers in the topology of the target system. Continuing with the example above where the topology includes three component layers (e.g., network, node and failure set), each system port of the target system would be associated with a particular network portion (e.g., a network subnet), a particular node (e.g., a storage node), and a particular failure set. In generating a discovery response, the target system adds entries for each of its system ports to a discovery output list one at a time. The priority of the component layers in the topology of the target system is used to assign weights to the “distance” between system ports. For example, system ports in different network subnets may be assigned a weight value of 3, while system ports of different nodes may be assigned a weight value of 2, and system ports belonging to different failure sets may be assigned a weight value of 1. Given a discovery output list header, the following entry selects a system port which maximizes the distance from the system port in the previous entry (e.g., the previous system port instance on the output list header).

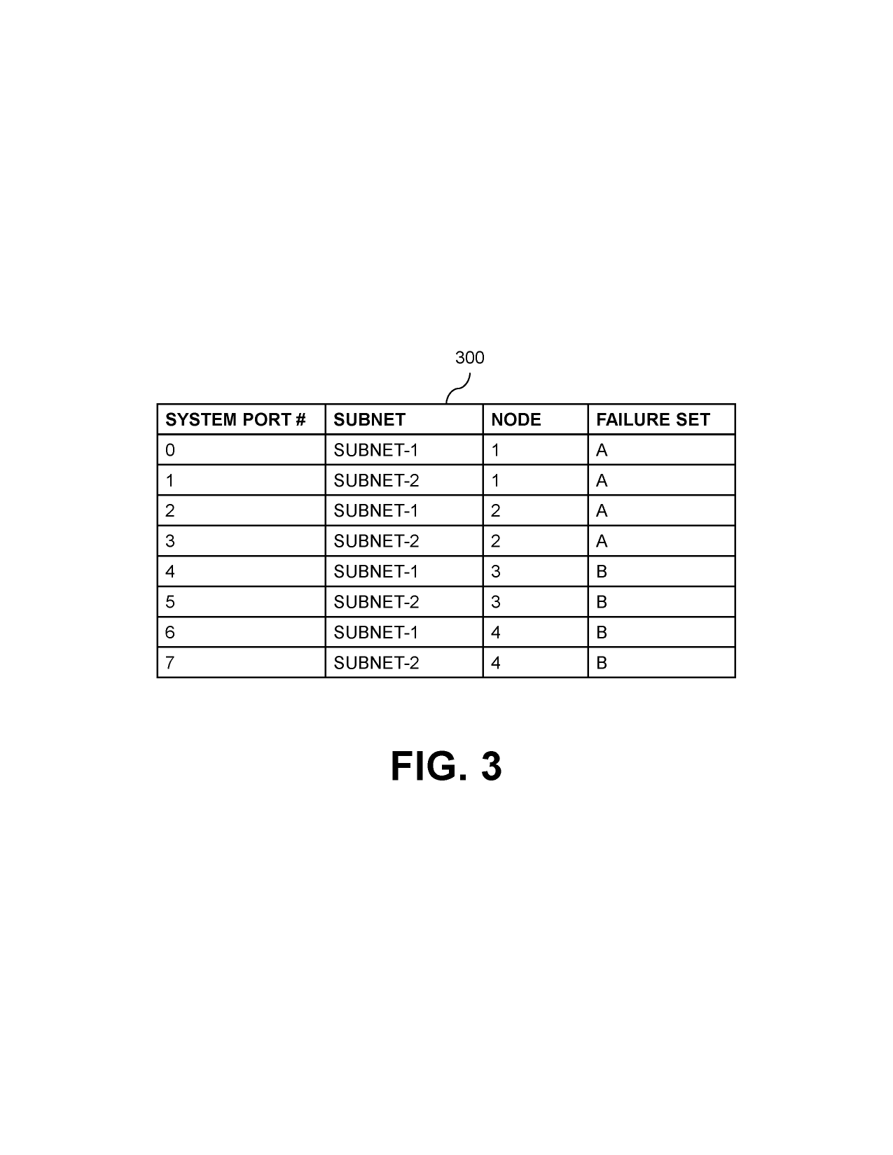

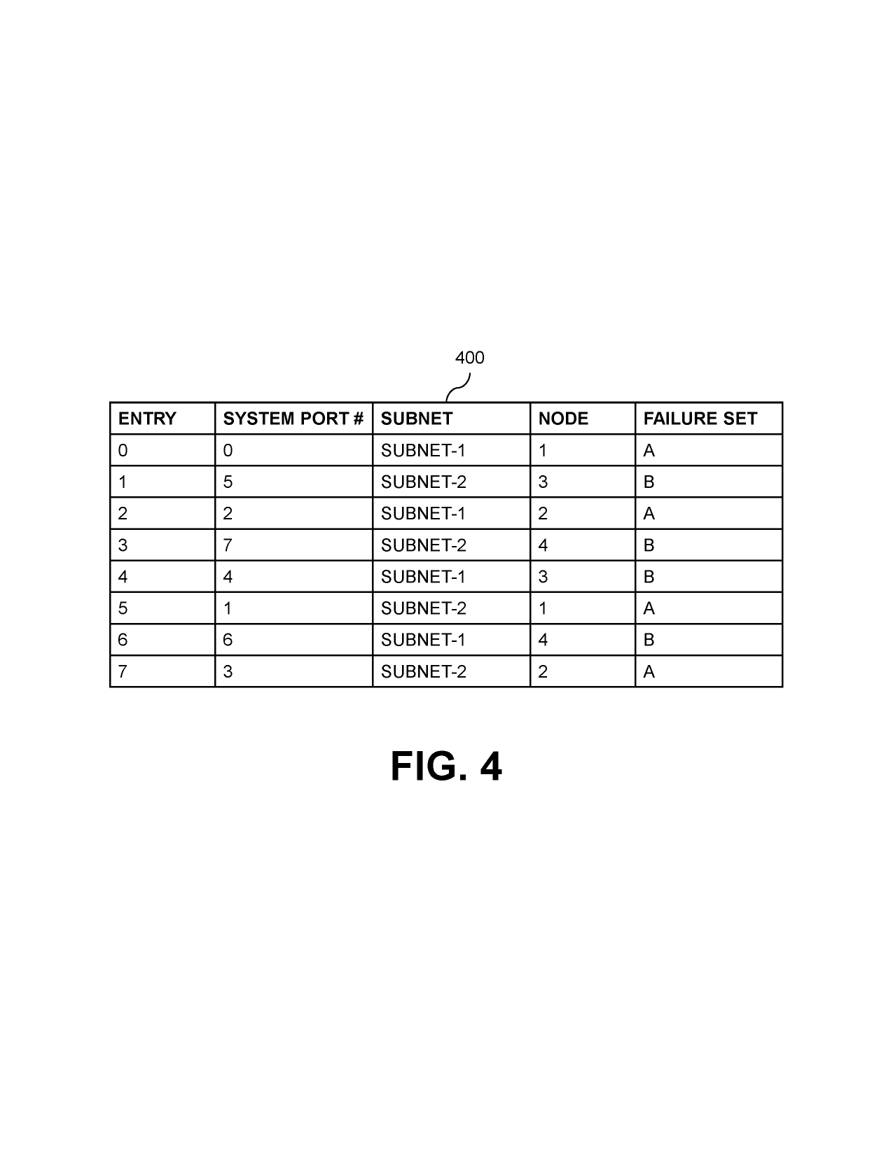

Consider, for example, a target system (e.g., a target storage system) with two network subnets, four nodes, and two failure sets. FIG. 3 shows a table 300 summarizing the system ports of the target system, including the network subnet, node (e.g., storage node) and failure set to which each system port belongs. In this example, there are eight system ports which are assigned system port numbers 0 through 7. FIG. 4 shows a table 400 illustrating a discovery output list for the target system, where the discovery output list includes eight entries (numbered 0 through 7) which orders the system ports in such a way that a source system (e.g., a source storage system) receiving the discovery output list as part of a discovery response will be able to intelligently select the system ports of the target system to which each initiator of the source system will connect to establish resilient and balanced connections between the source and target systems.

The source system (e.g., a scale-out initiator) selects the system ports of the target system to which each initiator of the source system will connect. This selection can be managed in different ways, including a centralized selection approach and a distributed selection approach.

In the centralized selection approach, a central component (e.g., a management node such as one of the management nodes 215, a metadata manager (MDM) component, a designated storage or compute node of the source system, etc.) assigns each initiator of the source system a set of system ports of the target system to connect to. The central component assigns each initiator a set of system ports of the target system that are consecutive in the discovery output list (e.g., the table 400 shown in FIG. 4), knowing that consecutive entries are spread over the component layers. The central component also ensures that there is a similar (but not necessarily equal) number of connections to each system port of the target system in the discovery output list.

In the distributed selection solution, the central component may be used to assign each initiator of the source system an ordinal number (ON) (e.g., 1, 2, 3, 4, ….). The central component may also determine the number of initiator connections (NICON) that each initiator of the source system should establish with the target system. Each initiator of the source system may perform discovery individually, and receive a discovery response (e.g., the discovery output list shown in table 400 of FIG. 4) from the target system. Thus, all initiators of the source system will receive the same discovery output list. A given initiator calculates its entry index (EI) in the discovery output list based on its assigned ON. For example, EI = (ON-1)*NICON. If the calculated EI is larger than the size of discovery output list (e.g., where the size of the discovery output list is the number of entries in the discovery output list), then EI = EI – sizeof(Discovery_List). The given initiator connects to NICON number of system ports of the target system, starting from the entry with the index EI calculated for the given initiator. It should be noted that, when initiators are added or removed from the source system, the ONs assigned to the initiators will be reassigned (e.g., by the central component).

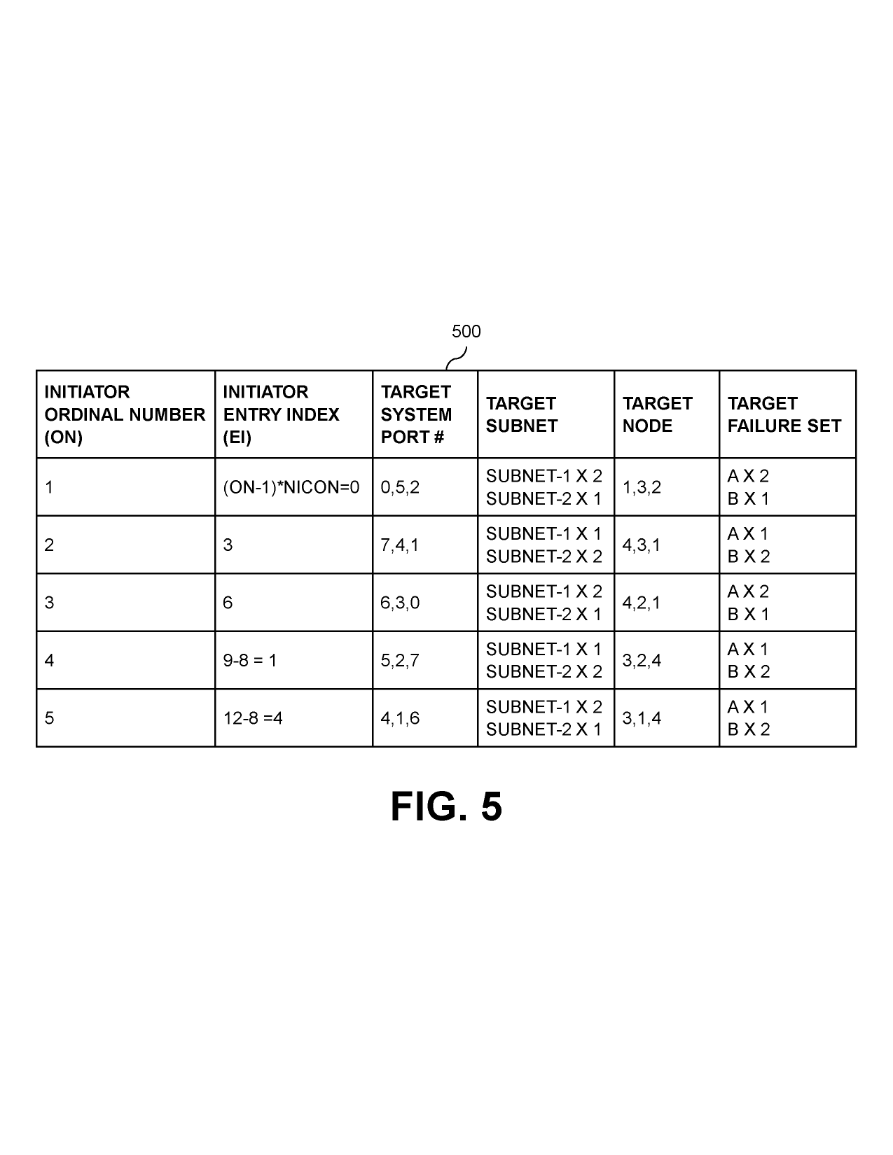

Continuing with the example discovery output list shown in the table 400 of FIG. 4, an example implementation of the distributed selection solution will now be described. The central component assigns each initiator of the source system an ON, starting with ON=0. In this example, it is assumed that there are five initiators in the source system, and that the number of connections that each initiator will create to the target system, NICON, is three. FIG. 5 shows a table 500, listing the connections which each initiator of the source system will make given the example discovery output list shown in the table 400 of FIG. 4. Each initiator connection is resilient to a failure in multiple component layers (e.g., failure of a network subnet, failure of a node of the target system, and a failure set). For example, the initiator with ON=1 will connect to system port numbers 0, 5 and 2 of the target system, which include: two system ports on subnet-1 and one system port on subnet-2; one system port on each of three different nodes 1, 3 and 2 of the target system; and two system ports in failure set A and one system port in failure set B. The number of connections to each target resource is approximately equal. For the network subnets, there are 8 connections to subnet-1 and 7 connections to subnet-2. For nodes of the target system, there are 4 connections to node 1, 3 connections to node 2, 4 connections to node 3, and 4 connections to node 4. For failure sets, there are 7 connections to failure set A and 8 connections to failure set B.

The technical solutions described herein provide various technical advantages. The target system (e.g., a target storage system) is aware of its topology and the implications of its topology on failure at different component layers (e.g., network, node, failure set, etc.), and is configured to create discovery output accordingly (e.g., with a particular ordering of entries that allows initiators on a source system to intelligently select system ports of the target system to connect to that will achieve a desired resiliency across component layers in the topology of the target system). The target system transmits, in discovery responses sent to initiators of the source system which send discovery requests to the target system, the implications of the topology of the target system through a specific ordering of the entries for system ports of the target system. This may advantageously utilize standard discovery protocols, such as iSCSI and NVMe protocols, without requiring any changes to such standard discovery protocols. The initiators of the source system use the discovery response information (e.g., the ordering of entries in a discovery output list) to connect resiliently to the target system, and to balance connections to the target system over target resources without requiring the initiators to know the topology of the target system. It should be noted that while various embodiments are described with respect to establishing resilient connections across three component layers (e.g., network, node and failure set), the technical solutions can be used to protect against any desired types of failure in any desired types of component layers in the topology of a target system. The initiator’s selection of system ports of the target system to connect to, in some embodiments, may be distributed (e.g., not requiring involvement of a central component), which eliminates a possible bottleneck in network events that require reconnection.

The technical solutions described herein thus address various technical challenges of conventional approaches. For example, full mesh connectivity between source (e.g., initiator) and target (e.g., destination) systems does not scale for systems with many nodes. User-configured connectivity requires significant manual effort to plan the connectivity and provide the source system with the plan. Such manual planning of the connections is error-prone, and requires updates if the system configuration changes. Another approach is to enhance or modify existing discovery protocols (e.g., NVMe, iSCSI, etc.) to allow a target or destination system to provide additional information in a discovery output (e.g., indicating a topology of the destination system) to allow a source or initiator system to compute resilient and balanced connections.

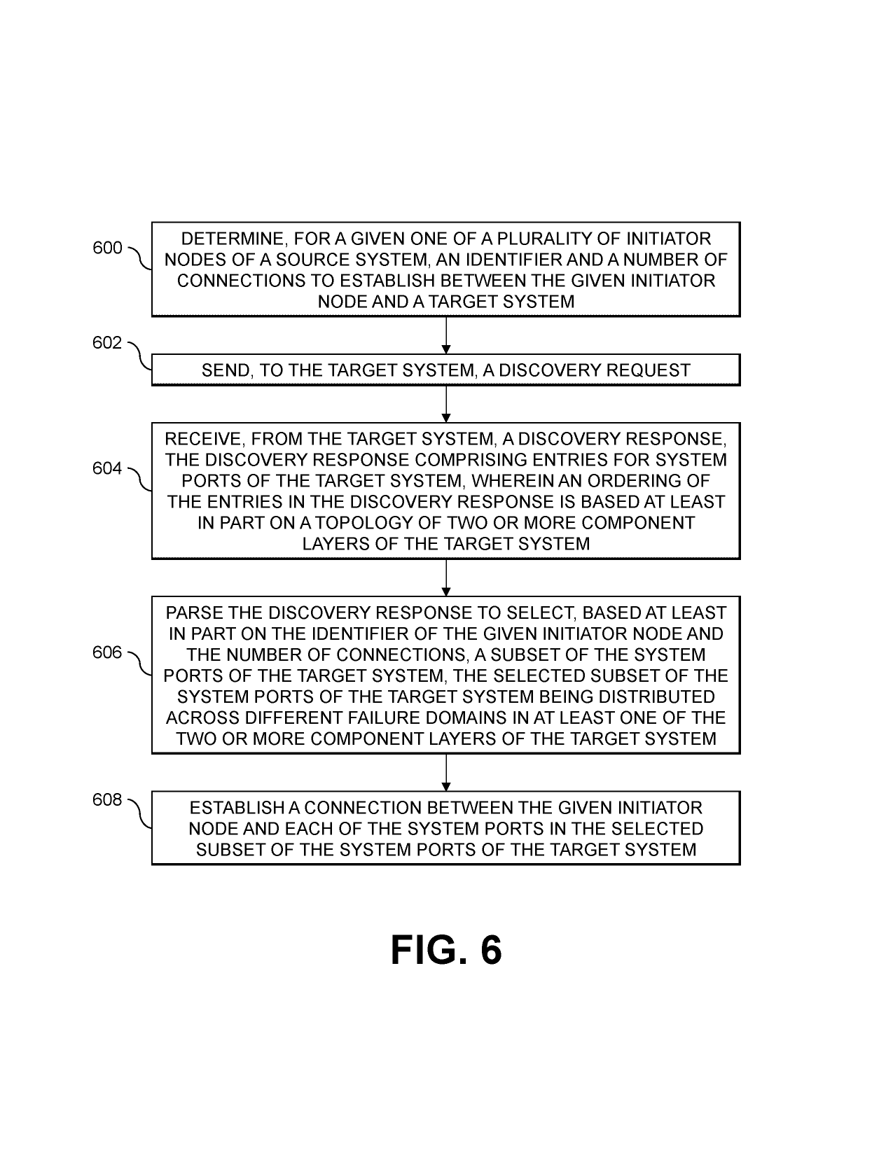

FIG. 6 is a flow diagram of a process for connection establishment across failure domains in component layers of a target system according to an exemplary embodiment of the disclosure. The process as shown in FIG. 6 includes steps 600 through 608. For purposes of illustration, the process flow of FIG. 6 will be discussed in the context of the information processing system 100 shown in FIG. 1.

At step 600, an identifier and a number of connections to establish between a given one of a plurality of initiator nodes (e.g., nodes 110) of a source system (e.g., source system 101) and a target system (e.g., target system 103) are determined. The source system may comprise a first storage system and the target system may comprise a second storage system. The target system may comprise a scale-out storage system. The identifier for the given initiator node may comprise an ordinal number, where each of the plurality of initiator nodes of the source system is assigned a different ordinal number. The ordinal numbers may be updated responsive to adding or removing initiator nodes of the source system.

At step 602, a discovery request is sent to the target system. This may include, for example, sending the discovery request from one of the nodes 110 of the source system 101 to one of the nodes 130 of the target system 103.

At step 604, a discovery response is received from the target system. The discovery response comprises entries for system ports of the target system. An ordering of the entries in the discovery response is based at least in part on a topology of two or more component layers of the target system. The two or more component layers of the target system may comprise a network component layer, a node component layer, and a failure set component layer. The ordering of the entries in the discovery response may be selected to maximize a distance between the system ports in each of the two or more component layers of the target system. The two or more component layers may be associated with different priorities, the different priorities being utilized to weight distances between system ports of the storage system.

At step 606, the discovery response is parsed to select, based at least in part on the identifier of the given initiator node and the number of connections determined in step 600, a subset of the system ports of the target system. The selected subset of the system ports of the target system are distributed across different failure domains in at least one of the two or more component layers of the target system. Step 606 may include selecting a starting entry in the discovery response based at least in part on the identifier of the given initiator node, and selecting a consecutive number of entries in the discovery response beginning with the starting entry, the consecutive number of entries corresponding to the number of connections to establish between the given initiator node and the target system. The identifier of the given initiator node may be an ordinal number, and if the ordinal number exceeds a number of entries in the discovery response, the starting entry is selected by subtracting the number of entries in the discovery response from the ordinal number until a result is less than the number of entries in the discovery response. The selected subset of the system ports of the target system may comprise at least one system port in a first network subnet in a network component layer of the target system and at least one system port in a second network subnet in the network component layer of the target system. The selected subset of the system ports of the target system may comprise at least one system port of a first node in a node component layer of the target system and at least one system port of a second node in the node component layer of the target system. The selected subset of the system ports of the target system may comprise at least one system port in a first failure set in a failure set component layer of the target system and at least one system port in a second failure set in the failure set component layer of the target system. Step 606 may be performed by the given initiator node, or by a management node in communication with the given initiator node.

In step 608, a connection is established between the given initiator node and each of the system ports in the selected subset of the system ports of the target system.

The particular processing operations and other system functionality described above in conjunction with the flow diagram of FIG. 6 are presented by way of illustrative examples only, and should not be construed as limiting the scope of the disclosure in any way. Alternative embodiments can use other types of processing operations for implementing functionality for connection establishment across failure domains in component layers of a target system. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 6 can be implemented at least in part in the form of one or more software programs stored in memory and executed by a processor of a processing device such as a computer or server.

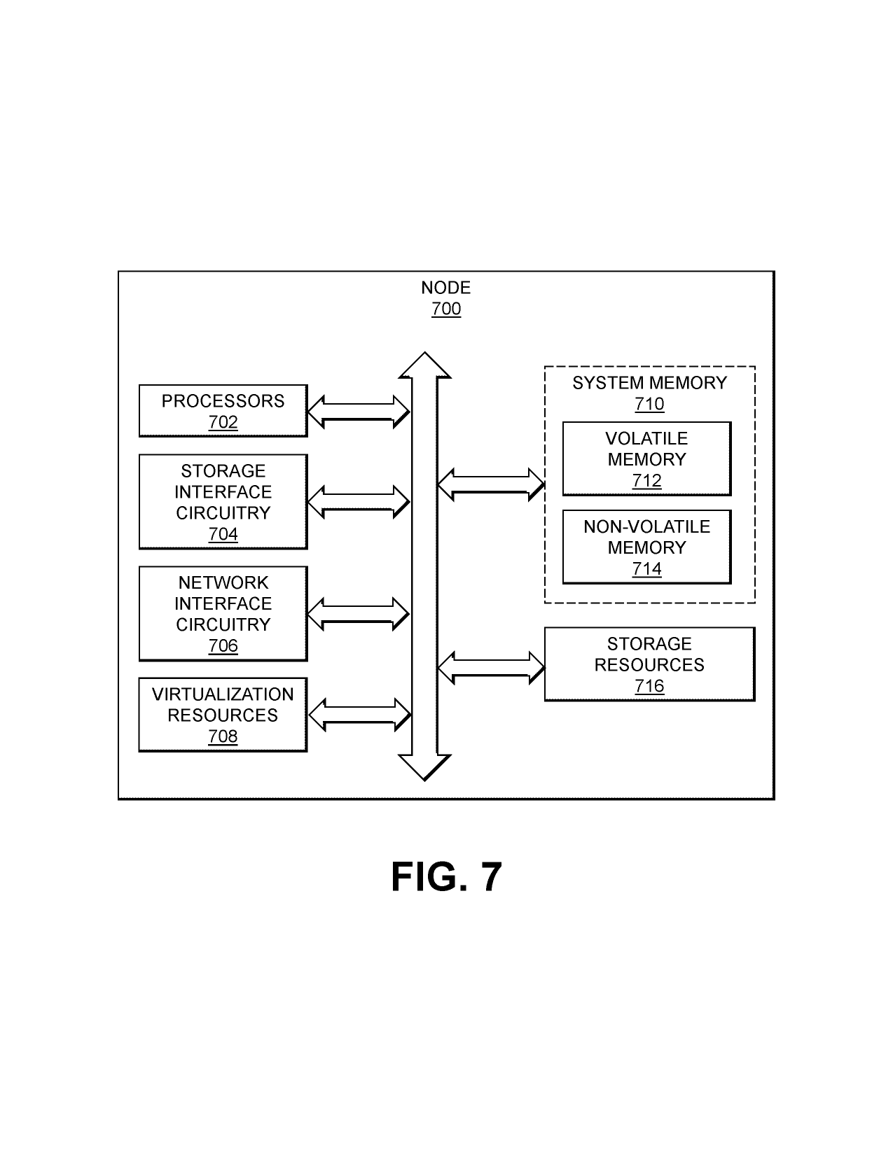

FIG. 7 schematically illustrates a framework of a system node 700 (e.g., one or more the nodes 110 and/or the nodes 130 in the information processing system 100 of FIG. 1, one or more of the compute nodes 210, the management nodes 215 and/or storage nodes 240 in the information processing system 200 of FIGS. 2A-2C), which can be implemented for hosting a storage control system (e.g., the storage controllers 242, FIG. 2C). The system node 700 comprises processors 702, storage interface circuitry 704, network interface circuitry 706, virtualization resources 708, system memory 710, and storage resources 716. The system memory 710 comprises volatile memory 712 and non-volatile memory 714.

The processors 702 comprise one or more types of hardware processors that are configured to process program instructions and data to execute a native operating system (OS) and applications that run on the system node 700. For example, the processors 702 may comprise one or more CPUs, microprocessors, microcontrollers, application specific integrated circuits (ASICs), field programmable gate arrays (FPGAs), and other types of processors, as well as portions or combinations of such processors. The term “processor” as used herein is intended to be broadly construed so as to include any type of processor that performs processing functions based on software, hardware, firmware, etc. For example, a “processor” is broadly construed so as to encompass all types of hardware processors including, for example, (i) general purpose processors which comprise “performance cores” (e.g., low latency cores), and (ii) workload-optimized processors, which comprise any possible combination of multiple “throughput cores” and/or multiple hardware-based accelerators. Examples of workload-optimized processors include, for example, graphics processing units (GPUs), digital signal processors (DSPs), system-on-chip (SoC), tensor processing units (TPUs), image processing units (IPUs), deep learning accelerators (DLAs), artificial intelligence (AI) accelerators, and other types of specialized processors or coprocessors that are configured to execute one or more fixed functions.

The storage interface circuitry 704 enables the processors 702 to interface and communicate with the system memory 710, the storage resources 716, and other local storage and off-infrastructure storage media, using one or more standard communication and/or storage control protocols to read data from or write data to volatile and non-volatile memory/storage devices. Such protocols include, but are not limited to, NVMe, peripheral component interconnect express (PCIe), Parallel ATA (PATA), SATA, SAS, Fibre Channel, etc. The network interface circuitry 706 enables the system node 700 to interface and communicate with a network and other system components. The network interface circuitry 706 comprises network controllers such as network cards and resources (e.g., network interface controllers (NICs) including SmartNICs, RDMA-enabled NICs, etc., Host Bus Adapter (HBA) cards, Host Channel Adapter (HCA) cards, IO adaptors, converged Ethernet adaptors, etc.) to support communication protocols and interfaces including, but not limited to, PCIe, DMA and RDMA data transfer protocols, etc.

The virtualization resources 708 can be instantiated to execute one or more services or functions which are hosted by the system node 700. For example, the virtualization resources 708 can be configured to implement the various modules and functionalities of the nodes 110 and/or the nodes 130 shown in FIG. 1, the management nodes 215 as shown in FIG. 2A, the compute nodes 210 as shown in FIG. 2B, or the storage controllers 242 as shown in FIG. 2C as discussed herein. In some embodiments, the virtualization resources 708 comprise virtual machines that are implemented using a hypervisor platform which executes on the system node 700, wherein one or more virtual machines can be instantiated to execute functions of the system node 700. As is known in the art, virtual machines are logical processing elements that may be instantiated on one or more physical processing elements (e.g., servers, computers, or other processing devices). That is, a “virtual machine” generally refers to a software implementation of a machine (i.e., a computer) that executes programs in a manner similar to that of a physical machine. Thus, different virtual machines can run different operating systems and multiple applications on the same physical computer.

A hypervisor is an example of what is more generally referred to as “virtualization infrastructure.” The hypervisor runs on physical infrastructure, e.g., CPUs and/or storage devices, of the system node 700, and emulates the CPUs, memory, hard disk, network and other hardware resources of the host system, enabling multiple virtual machines to share the resources. The hypervisor can emulate multiple virtual hardware platforms that are isolated from each other, allowing virtual machines to run, e.g., Linux and Windows Server operating systems on the same underlying physical host. The underlying physical infrastructure may comprise one or more commercially available distributed processing platforms which are suitable for the target application.

In other embodiments, the virtualization resources 708 comprise containers such as Docker containers or other types of Linux containers (LXCs). As is known in the art, in a container-based application framework, each application container comprises a separate application and associated dependencies and other components to provide a complete filesystem, but shares the kernel functions of a host operating system with the other application containers. Each application container executes as an isolated process in user space of a host operating system. In particular, a container system utilizes an underlying operating system that provides the basic services to all containerized applications using virtual-memory support for isolation. One or more containers can be instantiated to execute one or more applications or functions of the system node 700 as well as execute one or more of the various modules and functionalities of the nodes 110, the nodes 130, the management nodes 215, the compute nodes 210 or the storage controllers 242 as discussed herein. In yet other embodiments, containers may be used in combination with other virtualization infrastructure such as virtual machines implemented using a hypervisor, such as where Docker containers or other types of LXCs are configured to run on virtual machines in a multi-tenant environment.

In some embodiments, the various components, systems, and modules of the nodes 110, the nodes 130, the management nodes 215, the compute nodes 210 and/or the storage controllers 242 comprise program code that is loaded into the system memory 710 (e.g., volatile memory 712), and executed by the processors 702 to perform respective functions as described herein. In this regard, the system memory 710, the storage resources 716, and other memory or storage resources as described herein, which have program code and data tangibly embodied thereon, are examples of what is more generally referred to herein as “processor-readable storage media” that store executable program code of one or more software programs. Articles of manufacture comprising such processor-readable storage media are considered embodiments of the disclosure. An article of manufacture may comprise, for example, a storage device such as a storage disk, a storage array or an integrated circuit containing memory. The term “article of manufacture” as used herein should be understood to exclude transitory, propagating signals.

The system memory 710 comprises various types of memory such as volatile RAM, NVRAM, or other types of memory, in any combination. The volatile memory 712 may be a dynamic random-access memory (DRAM) (e.g., DRAM DIMM (Dual In-line Memory Module)), or other forms of volatile RAM. The non-volatile memory 714 may comprise one or more of NAND Flash storage devices, SSD devices, or other types of next generation non-volatile memory (NGNVM) devices. The system memory 710 can be implemented using a hierarchical memory tier structure wherein the volatile memory 712 is configured as the highest-level memory tier, and the non-volatile memory 714 (and other additional non-volatile memory devices which comprise storage-class memory) is configured as a lower level memory tier which is utilized as a high-speed load/store non-volatile memory device on a processor memory bus (e.g., data is accessed with loads and stores, instead of with IO reads and writes). The term “memory” or “system memory” as used herein refers to volatile and/or non-volatile memory which is utilized to store application program instructions that are read and processed by the processors 702 to execute a native operating system and one or more applications or processes hosted by the system node 700, and to temporarily store data that is utilized and/or generated by the native OS and application programs and processes running on the system node 700. The storage resources 716 can include one or more HDDs, SSD storage devices, etc.

It should again be emphasized that the above-described embodiments are presented for purposes of illustration only. Many variations and other alternative embodiments may be used. For example, the disclosed techniques are applicable to a wide variety of other types of information processing systems, storage systems, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine, for a given one of a plurality of initiator nodes of a source system, an identifier and a number of connections to establish between the given initiator node and a target system;
to send, to the target system, a discovery request;
to receive, from the target system, a discovery response, the discovery response comprising entries for system ports of the target system, wherein an ordering of the entries in the discovery response is based at least in part on a topology of two or more component layers of the target system;
to parse the discovery response to select, based at least in part on the identifier of the given initiator node and the number of connections, a subset of the system ports of the target system, the selected subset of the system ports of the target system being distributed across different failure domains in at least one of the two or more component layers of the target system; and
to establish a connection between the given initiator node and each of the system ports in the selected subset of the system ports of the target system.

2. The apparatus of claim 1 wherein the source system comprises a first storage system and the target system comprises a second storage system.

3. The apparatus of claim 1 wherein the target system comprises a scale-out storage system.

4. The apparatus of claim 1 wherein the identifier for the given initiator node comprises an ordinal number, wherein each of the plurality of initiator nodes of the source system is assigned a different ordinal number.

5. The apparatus of claim 1 wherein the at least one processing device comprises a management node external to the given initiator node, and wherein establishing the connection between the given initiator node and each of the system ports in the selected subset of the system ports of the target system comprises the management node instructing the given initiator node of the selected subset of the system ports of the target system.

6. The apparatus of claim 1 wherein the at least one processing device comprises the given initiator node.

7. The apparatus of claim 1 wherein the two or more component layers of the target system comprises a network component layer, a node component layer, and a failure set component layer.

8. The apparatus of claim 1 wherein the ordering of the entries in the discovery response is selected to maximize a distance between the system ports in each of the two or more component layers of the target system.

9. The apparatus of claim 8 wherein the two or more component layers are associated with different priorities, the different priorities being utilized to weight distances between system ports of the target system.

10. The apparatus of claim 1 wherein parsing the discovery response comprises selecting a starting entry in the discovery response based at least in part on the identifier of the given initiator node, and selecting a consecutive number of entries in the discovery response beginning with the starting entry, the consecutive number of entries corresponding to the number of connections to establish between the given initiator node and the target system.

11. The apparatus of claim 10 wherein the identifier of the given initiator node is an ordinal number, and if the ordinal number exceeds a number of entries in the discovery response, the starting entry is selected by subtracting the number of entries in the discovery response from the ordinal number until a result is less than the number of entries in the discovery response.

12. The apparatus of claim 1 wherein the selected subset of the system ports of the target system comprises at least one system port in a first network subnet in a network component layer of the target system and at least one system port in a second network subnet in the network component layer of the target system.

13. The apparatus of claim 1 wherein the selected subset of the system ports of the target system comprises at least one system port of a first node in a node component layer of the target system and at least one system port of a second node in the node component layer of the target system.

14. The apparatus of claim 1 wherein the selected subset of the system ports of the target system comprises at least one system port in a first failure set in a failure set component layer of the target system and at least one system port in a second failure set in the failure set component layer of the target system.

15. A computer program product comprising a non-transitory processor-readable storage medium having stored therein program code of one or more software programs, wherein the program code when executed by at least one processing device causes the at least one processing device:
to determine, for a given one of a plurality of initiator nodes of a source system, an identifier and a number of connections to establish between the given initiator node and a target system;
to send, to the target system, a discovery request;
to receive, from the target system, a discovery response, the discovery response comprising entries for system ports of the target system, wherein an ordering of the entries in the discovery response is based at least in part on a topology of two or more component layers of the target system;
to parse the discovery response to select, based at least in part on the identifier of the given initiator node and the number of connections, a subset of the system ports of the target system, the selected subset of the system ports of the target system being distributed across different failure domains in at least one of the two or more component layers of the target system; and
to establish a connection between the given initiator node and each of the system ports in the selected subset of the system ports of the target system.

16. The computer program product of claim 15 wherein the two or more component layers of the target system comprises a network component layer, a node component layer, and a failure set component layer.

17. The computer program product of claim 15 wherein parsing the discovery response comprises selecting a starting entry in the discovery response based at least in part on the identifier of the given initiator node, and selecting a consecutive number of entries in the discovery response beginning with the starting entry, the consecutive number of entries corresponding to the number of connections to establish between the given initiator node and the target system.

18. A method comprising:
determining, for a given one of a plurality of initiator nodes of a source system, an identifier and a number of connections to establish between the given initiator node and a target system;
sending, to the target system, a discovery request;
receiving, from the target system, a discovery response, the discovery response comprising entries for system ports of the target system, wherein an ordering of the entries in the discovery response is based at least in part on a topology of two or more component layers of the target system;
parsing the discovery response to select, based at least in part on the identifier of the given initiator node and the number of connections, a subset of the system ports of the target system, the selected subset of the system ports of the target system being distributed across different failure domains in at least one of the two or more component layers of the target system; and
establishing a connection between the given initiator node and each of the system ports in the selected subset of the system ports of the target system;
wherein the method is performed by at least one processing device comprising a processor coupled to a memory.

19. The method of claim 18 wherein the two or more component layers of the target system comprises a network component layer, a node component layer, and a failure set component layer.

20. The method of claim 18 wherein parsing the discovery response comprises selecting a starting entry in the discovery response based at least in part on the identifier of the given initiator node, and selecting a consecutive number of entries in the discovery response beginning with the starting entry, the consecutive number of entries corresponding to the number of connections to establish between the given initiator node and the target system.
